(19) United States
(12) Patent Application Publication
(10) Pub. No.: US 2020/0003253 A1
(43) Pub. Date: Jan. 2, 2020

(54) FRICTION HINGES AND DEVICES

(71) Applicant: Koncept Technologies Inc., Monrovia, CA (US)

(72) Inventor: Hon Kit Peter Ng, Hong Kong (CN)

(21) Appl. No.: 16/022,621

(22) Filed: Jun. 28, 2018

(51) Int. Cl. F16C 11/10; F16C 11/04; F21V 21/26

(52) U.S. Cl. CPC F16C 11/103; F21V 21/26; F16C 11/045

(57) ABSTRACT

A friction joint includes a housing having a channel. A first tension ring member is arranged within the channel, and has an outer dimension that is resiliently expandable. A first rotor member is received within the central opening of the first tension ring member. The first rotor member causes the outer dimension of the first tension ring member to expand within the channel of the housing and press against at least a portion of the housing. The first rotor member is frictionally engaged with and rotatable relative to the first tension ring member when the first rotor member is received within the central opening of the first tension ring member.

### FIELD OF INVENTION

The present disclosure relates to certain friction joints and devices that include such friction joints, as well as methods of making and using such friction joints and devices. Particular embodiments relate to lighting devices that include such friction joints.

### SUMMARY

An example of a friction joint includes a housing having a channel, and a first tension ring member arranged within the channel. The first tension ring member has an outer dimension that is resiliently expandable. The first tension ring member having a central opening. A first rotor member is configured to be received within the central opening of the first tension ring member while the first tension ring member is within the channel of the housing. The first rotor member causes the outer dimension of the first tension ring member to expand within the channel of the housing and press against at least a portion of the housing when the first rotor member is received within the central opening of the first tension ring member. The first rotor member is frictionally engaged with and rotatable relative to the first tension ring member when the first rotor member is received within the central opening of the first tension ring member. A first lever member is secured to the first rotor, to rotate with the first rotor, relative to the first tension ring member.

A friction joint according to a further example includes a second tension ring member arranged within the channel, where the second tension ring member has an outer dimension that is resiliently expandable. The second tension ring member has a central opening. A second rotor member is configured to be received within the central opening of the second tension ring member while the second tension ring member is within the channel of the housing. The second rotor member causes the outer dimension of the second tension ring member to expand within the channel of the housing and abut against at least a portion of the housing when the second rotor member is received within the central opening of the second tension ring member. The second rotor member is frictionally engaged with and rotatable relative to the second tension ring member when the second rotor member is received within the central opening of the second tension ring member. A second lever member is secured to the second rotor, to rotate with the second rotor, relative to the second tension ring member.

In a further example of the above friction joints, the housing has a wall that divides the channel into first and second channel sections, wherein the first tension ring member is arranged within the first channel section of the channel, and the second tension ring member is arranged within the second channel section of the channel.

In a further example of the above friction joints, the wall of the housing has a first receptacle for receiving a portion of a connector member that extends through the first rotor member.

In a further example of the above friction joints, the wall of the housing has a second receptacle for receiving a portion of a second connector member that extends through the second rotor member.

In a further example of the above friction joints, the first tension ring member is configured to secure in a fixed relation to the housing when the first tension ring member is expanded within the channel of the housing and pressed against the portion of the housing.

In a further example of the above friction joints, the channel of the housing has a plurality of indentations, grooves or detents, and wherein the first tension ring member has an outer peripheral surface that has a plurality of spokes, ribs or knurls configured to be received within the plurality of indentations, grooves or detents in the channel of the housing, when the first tension ring member is expanded within the channel of the housing and pressed against the portion of the housing.

In a further example of the above friction joints, the plurality of indentations, grooves or detents are evenly spaced around and extend outward from a perimeter of the first tension ring.

In a further example of the above friction joints, the plurality of spokes, ribs or knurls includes a first pair of adjacent spokes, ribs or knurls and a second pair of adjacent spokes, ribs or knurls, wherein a spacing between the first pair of adjacent spokes, ribs or knurls is larger than a spacing between the second pair of spokes, ribs or knurls.

In a further example of the above friction joints, the first tension ring has a first radial thickness dimension in a region corresponding to the spacing between the first pair of adjacent spokes, ribs or knurls, and a second radial thickness in a region corresponding to the spacing between the second pair of adjacent spokes, ribs or knurls, and wherein the first radial thickness is smaller than the second radial thickness.

In a further example of the above friction joints, the plurality of spokes, ribs or knurls includes a plurality of first pairs of adjacent spokes, ribs or knurls and a plurality of second pairs of adjacent spokes, ribs or knurls, wherein a spacing between each first pair of adjacent spokes, ribs or knurls is larger than a spacing between each second pair of spokes, ribs or knurls.

In a further example of the above friction joints, the outer dimension of the first tension ring has a first diameter when the first rotor member is not within the central opening of the first tension ring member, and is expanded to a second diameter when the first rotor member is received within the central opening of the first tension ring member. In such further example, the second diameter is larger than the first diameter.

In a further example of the above friction joints, the channel of the housing has an open end, and the first outer diameter of the first tension ring member is sufficiently small relative to the channel of the housing to allow the first tension ring to be manually slid into or out of the open end of the channel of the housing. In such further example, the second outer diameter of the first tension ring member is sufficiently large relative to the channel of the housing to cause at least a portion of the first tension ring member to press against an inner surface of the channel.

In a further example of the above friction joints, the central opening of the first tension ring member defines an inner wall having at least two raised contact surfaces for engaging the first rotor member when the first rotor member is received within the central opening of the first tension ring member.

In a further example, a lighting device has a first structural member and a second structural member, where the second structural member contains or supports at least one light emitting device, and the first structural member and the second structural member being coupled together with the friction joint of any of the above examples, for pivotal motion relative to each other.

An example of a support system includes a first structural element, a second structural element and a friction joint connecting the first structural element and the second structural element for relative pivotal motion. In that example, the friction joint includes a housing having a channel, the housing being fixed to the first structural element. A first tension ring member is arranged within the channel. The first tension ring member has an outer dimension that is resiliently expandable. The first tension ring member having a central opening. A first rotor member is configured to be received within the central opening of the first tension ring member while the first tension ring member is within the channel of the housing. The first rotor member causes the outer dimension of the first tension ring member to expand within the channel of the housing and press against at least a portion of the housing when the first rotor member is received within the central opening of the first tension ring member. The first rotor member is frictionally engaged with and rotatable relative to the first tension ring member when the first rotor member is received within the central opening of the first tension ring member. A first lever member secured to the first rotor, to rotate with the first rotor, relative to the first tension ring member, the first lever member being fixed to the second structural element.

In a further example of the above support system, the first tension ring member is configured to secure in a fixed relation to the housing when the first tension ring member is expanded within the channel of the housing and pressed against the portion of the housing.

In a further example of the above support system, the channel of the housing has a plurality of indentations, grooves or detents, and the first tension ring member has an outer peripheral surface that has a plurality of spokes, ribs or knurls configured to be received within the plurality of indentations, grooves or detents in the channel of the housing, when the first tension ring member is expanded within the channel of the housing and pressed against the portion of the housing.

In a further example of the above support system, the outer dimension of the first tension ring has a first diameter when the first rotor member is not within the central opening of the first tension ring member, and is expanded to a second diameter when the first rotor member is received within the central opening of the first tension ring member. In such further example, the second diameter is larger than the first diameter.

In a further example of the above support system, the channel of the housing has an open end, and the first outer diameter of the first tension ring member is sufficiently small relative to the channel of the housing to allow the first tension ring to be manually slid into or out of the open end of the channel of the housing. In such further example, the second outer diameter of the first tension ring member is sufficiently large relative to the channel of the housing to cause at least a portion of the first tension ring member to press against an inner surface of the channel.

### BRIEF DESCRIPTION OF DRAWINGS

The above and other aspects and features of the present invention will become more apparent to those skilled in the art from the following detailed description of the example embodiments with reference to the accompanying drawings, in which:

FIG. 1 is a perspective view of an example of a friction joint.

FIG. 2 is a partial exploded, perspective view of the friction joint of FIG. 1.

FIG. 3 is a perspective view of an example of a tension ring member of the friction joint in FIG. 1.

FIG. 4 is a side view of certain components of the friction joint of FIG. 1.

FIG. 5 is a cross-section view of a rotor member of the friction joint of FIG. 1.

FIG. 6 is a perspective view of certain components of the friction joint of FIG. 1.

FIG. 7 is a partial cross-section, perspective view of the friction joint of FIG. 1.

FIG. 8 is a partial exploded, perspective view of a device having a friction joint of FIG. 1.

FIG. 9 is a partial perspective view of the device of FIG. 8.

FIG. 10 is a perspective view of a tension ring member of a friction joint, according to a further example.

FIG. 11 is a perspective view of another tension ring member of a friction joint, according to a further example.

FIG. 12 is a partial exploded, perspective view of a further example of a friction joint.

### DETAILED DESCRIPTION

Examples described herein relate to certain friction joints, and to certain devices that include such friction joints. Further examples relate to methods of making and using such friction joints and devices. Particular embodiments relate to lighting devices that include such friction joints. However, other examples relate to other types of devices having structural elements that are connected together for pivotal motion by a friction joint as described herein.

Hereinafter, example embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated. Further, features or aspects within each example embodiment should typically be considered as available for other similar features or aspects in other example embodiments.

Certain terminology may be used in the following description for the purpose of reference only, and thus are not intended to be limiting. For example, terms such as “top”, “bottom”, “upper”, “lower”, “above”, and “below” could be used to refer to directions in the drawings to which reference is made. Terms such as “front”, “back”, “rear”, and “side” could be used to describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

It will be understood that when an element or feature is referred to as being “on,” “connected to,” or “coupled to” another element or layer, it can be directly on, connected to, or coupled to the other element or feature, or one or more intervening elements or features may be present. In addition, it will also be understood that when an element or features is referred to as being “between” two elements or features, it can be the only element or feature between the two elements or features, or one or more intervening elements or features may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

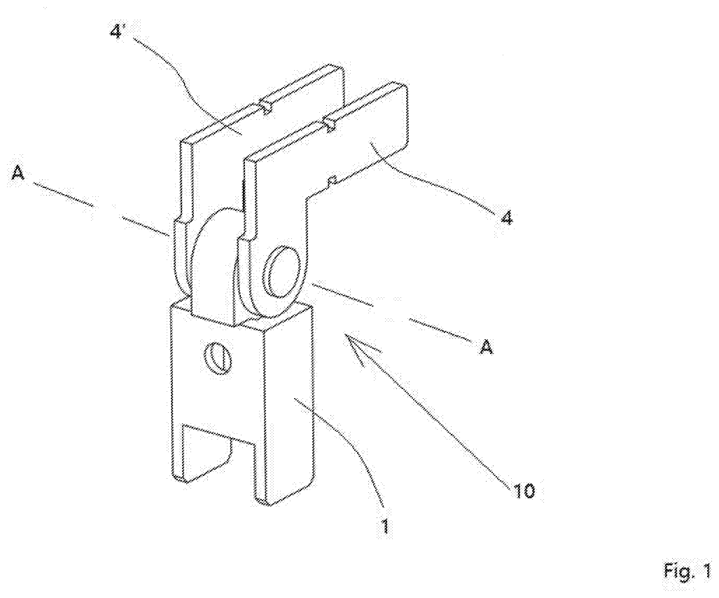

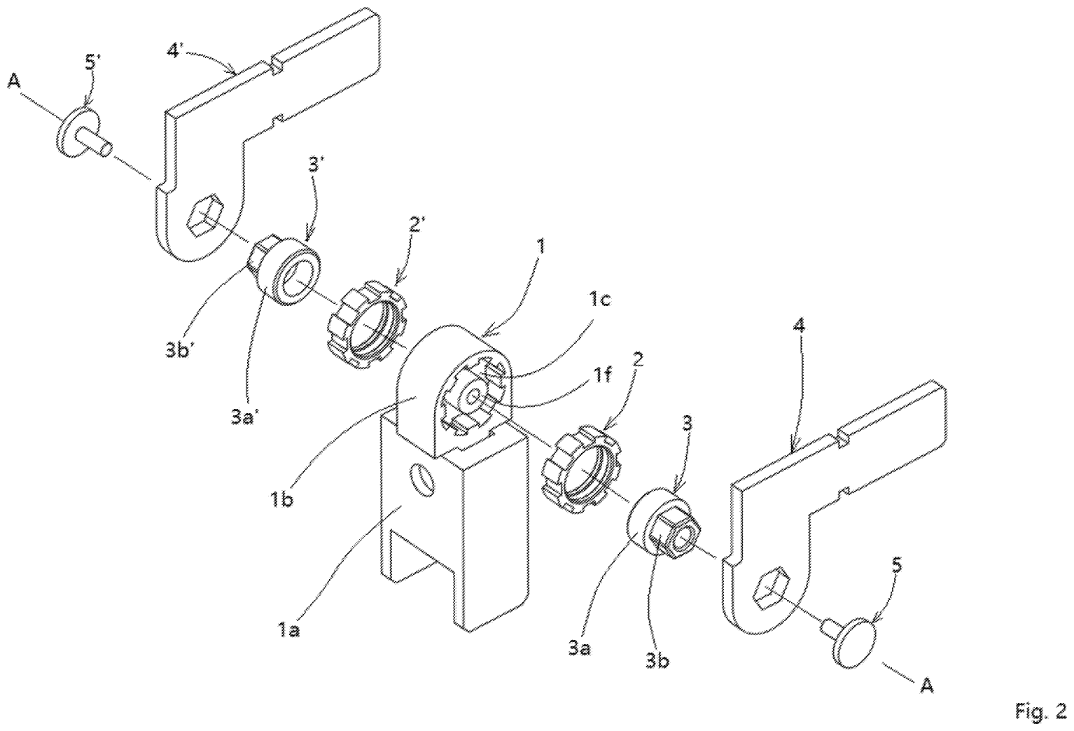

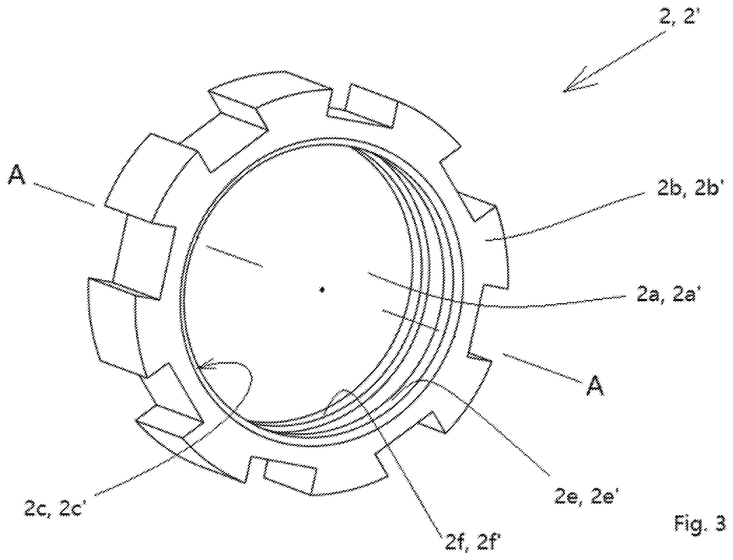

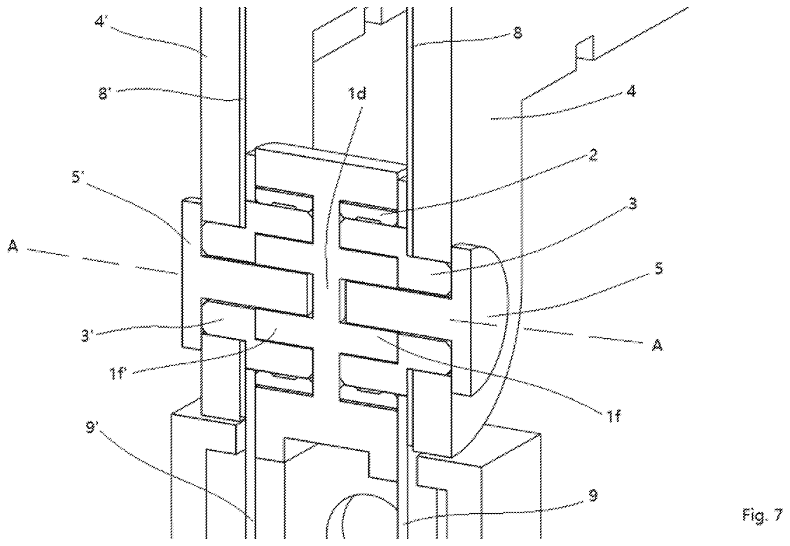

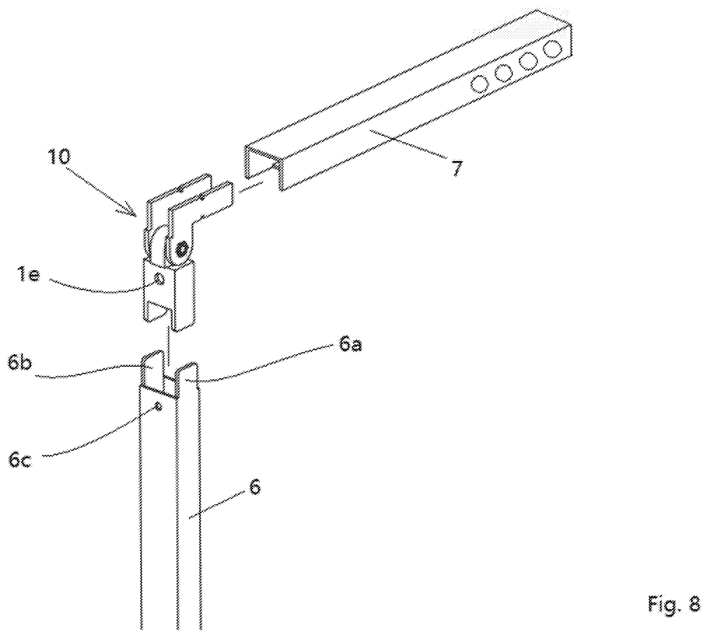

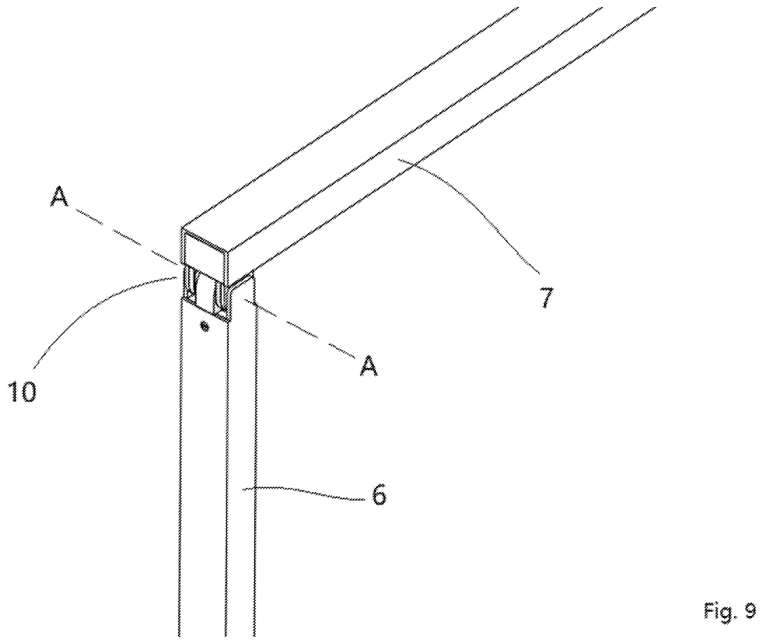

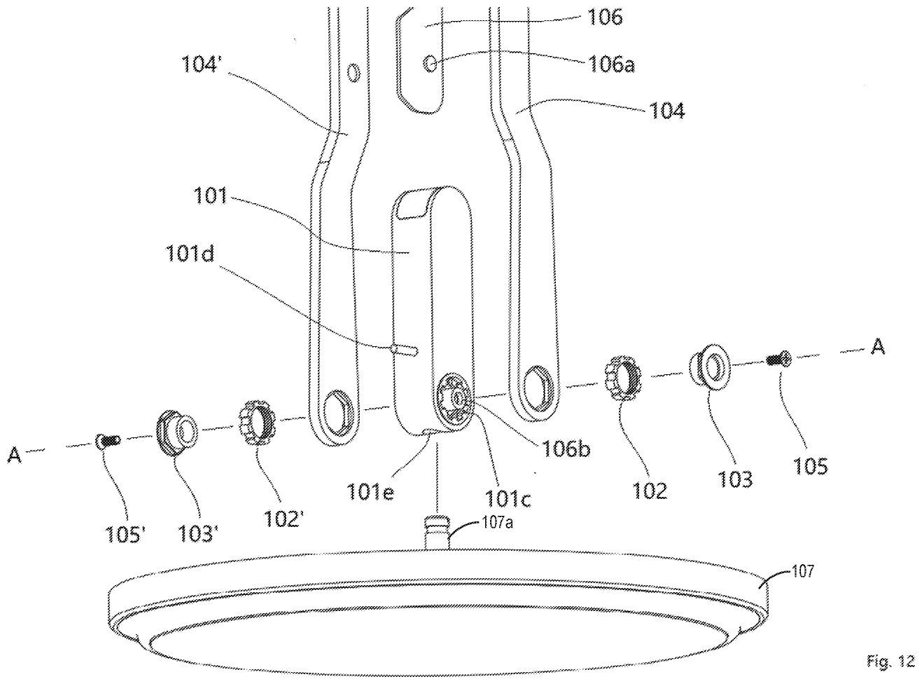

A friction joint 10 according to an example embodiment is shown in FIGS. 1 and 2. The friction joint 10 is shown in an assembled state in FIG. 1, and in a partial exploded view in FIG. 2. Examples of certain components of the friction joint 10 are shown in FIGS. 3-6. An example of a device that includes the friction joint 10 (and has structural components that attach to the friction joint 10) is shown in FIGS. 8 and 9. Further examples of friction joint components are described with reference to FIGS. 7 and 10-11. Another example of a friction joint 110 is shown in FIG. 12.

In the example in FIGS. 1 and 2, the friction joint 10 includes a housing 1 and first and second sets of further components. The first set of further components includes a first tension ring member 2, a first rotor member 3 and a first lever member 4, that are assembled on one side of the housing 1. The second set of further components includes a second tension ring member 2′ (similar to the first tension ring member 2), a second rotor member 3′ (which may be similar to the first rotor member 3) and a second lever member 4′ (which may be similar to the first lever member 4), that are assembled on a second side of the housing 1. One or more connector members 5 and 5′ may extend at least partially through the first and second rotor members 3 and 3′. In other examples, a friction joint may be configured similar to the friction joint 10, but with only one set of further components (either the first set of further components or the second set of further components) on one side of the housing 1.

When assembled, as shown in FIG. 1, the friction joint 10 is configured to allow pivotal movement of the lever members 4 and 4′ relative to the housing 1 and about an axis A, and to hold and maintain the lever members 4 and 4′ against gravity, in one or more (of multiple) different rotational positions about the axis A. In particular examples, the friction joint 10 provides a friction force sufficient to hold and maintain the position of the lever members 4 and 4′ against the force of gravity, but that can be overcome by application of a sufficient manual force, to allow manual adjustment of the pivotal position of the lever members 4 and 4′ relative to the housing 1 (about an axis A).

In certain examples described herein, a generally heavy duty configuration of the friction joint 10 may be capable of holding and maintaining the position (angular or pivotal position about axis A) of the lever members 4 and 4′, while also being capable of supporting a relatively large weight with the lever members 4 and 4′. Alternatively or in addition, example friction joints 10 as described herein may be configured to operate over a relatively long time period or relatively high levels of pivotal motion (or both). Furthermore, example friction joints 10 may have a configuration that provides for ease of manufacture and assembly.

In particular examples, some or all of the advantages described herein may be accomplished with a friction joint 10 having a relatively small size and dimensions. Thus, the friction joint 10 may be configured to have a size suitable for fitting into relatively small volume spaces (such as, but not limited to, a volume within or between adjustable arms of a lamp or other lighting device, a tool holder, or other device), yet also support a relatively large weight and provide further advantages as described herein. In other examples, the friction joint 10 may be configured to have any size and strength, suitable for the desired application of use.

The housing 1 includes a body portion 1a and a head portion 1b. The body portion 1a is configured to be mounted onto or within a structural element of a device, such as, but not limited to a lamp or other lighting device, a tool holding device, part holding device, television or monitor support or mounting device, book support or mounting device, computer mounting device, or the like. The head portion 1b of the housing includes a channel 1c that opens on at least one side of the head portion 1b. In certain examples, the channel 1c extends through the head portion 1b, and opens on the opposite-facing side of the head portion 1b, relative to the open side in view in FIG. 2. The open ends of the channel 1c serve as receptacles for the first and second tension ring members 2 and 2′.

In other examples (as in FIG. 7), the channel 1c extends into the head portion 1b and terminates at a wall portion 1d of the housing 1. In such other examples, a second opening and channel 1c extends into the opposite side of the housing 1 and terminates at the opposite side of the wall portion 1d, to serve as a receptacle for the second tension ring member 2′. In embodiments in which the friction joint 10 has only one set of further components, the channel 1c need only be open on and extend into one side of the head portion 1b, and serve as a receptacle for one of the tension ring members 2 or 2′. However, for purposes of simplifying the present description, examples are described herein as having two sets of further components (one on each of two opposite-facing sides of the housing 1). Those skilled in the art will understand that other examples need only include one set of further components on one side of the housing 1.

The tension ring members 2 and 2′ are received within the channel 1c of the housing 1 (e.g., on opposite sides of the head portion 1b of the housing 1). The rotor 3 is received within the tension ring member 2 and causes the tension ring member 2 to expand within the channel 1c. Similarly, the rotor 3′ is received within the tension ring member 2′ and expands the tension ring member 2′ within the channel 1c. The shape of the inner-facing peripheral surface of the channel 1c and the shape of the outer-facing peripheral surfaces of the tension ring members 2 and 2′ are configured to allow the surfaces to engage and inhibit relative rotation between the tension ring members 2 and 2′ and the housing 1, when the tension ring members 2 and 2′ are within the channel 1c and are expanded by the rotor member 3. In particular examples, the tension ring members 2 and 2′ are configured to tightly engage and be fixedly secured to the housing 1, when the tension ring members 2 and 2′ are received within the channel 1c and expanded by the rotor member 3.

When the rotor members 3 and 3′ are located in the tension ring members 2 and 2′ (as described below), the outer surfaces of the rotor members 3 and 3′ frictionally engage with the inner surfaces of the tension ring members 2 and 2′ with sufficient friction force to inhibit rotation of the rotor members 3 and 3′ by gravity (e.g., by gravity acting on a structural member to which the levers 4 and 4′ are to be attached). However, the outer surfaces of the rotor members 3 and 3′ and the inner surfaces of the tension ring members 2 and 2′ are rounded to allow rotation of rotor members 3 and 3′ (about the axis A) relative to the tension ring members 2 and 2′, when sufficient torque is applied to one or both of the rotor members 3 and 3′ to overcome the friction force.

The lever member 4 connects to the rotor member 3, in a fixed (non-rotatable) manner relative to the rotor member 3, but is rotatable (with the rotor 3) relative to the tension ring member 2. Similarly, the lever member 4′ connects to the rotor member 3′, in a fixed (non-rotatable) manner relative to the rotor member 3′, but is rotatable (with the rotor 3′) relative to the tension ring member 2′. The connector members 5 and 5′ may secure the lever members 4 and 4′ to the rotor members 3 and 3′.

Accordingly, rotational movement of the lever members 4 and 4′ about the axis A causes the rotor members 3 and 3′ to rotate within the tension ring members 2 and 2′. The frictional engagement of the rotor members 3 and 3′ with the tension ring members 2 and 2′ provides some resistance to the rotational movement and maintains the lever members 4 and 4′ in a rotationally adjusted position. In this manner, a force (such as, but not limited to a manual force) may be applied to the lever members 4 and 4′ (or to a structural element of a device to which the lever members are attached), to adjust the rotational position of the lever members (and the structural element to which the lever members are attached), relative to the housing 1 (or relative to a further structural element to which the housing 1 is attached).

The housing 1 may be made of any suitably rigid material or materials including, but not limited to plastic, metal, ceramic, wood, composite material, or the like. In certain examples, the housing 1 is made of an electrically insulating plastic or other electrically insulating material. The housing 1 may be formed as a single, unitary structure or in multiple parts coupled together. The housing 1 may be formed by any suitable manufacturing process or processes, including but not limited to molding, machining, extruding, or combinations thereof.

In particular examples, the channel 1c in the housing 1 has a diameter and shape that corresponds to the outer diameter and shape of the tension ring members 2 and 2′, such that the tension ring members 2 and 2′ are able to fit within the channel 1c during assembly. Once the tension ring members 2 and 2′ are located within the channel 1c, the rotor members 3 and 3′ may be pressed into respective central openings 2a and 2a′ in the tension ring members 2 and 2′, causing the tension ring members 2 and 2′ to expand within the channel 1c of the housing 1. As discussed above, the shape of the inner-facing peripheral surface of the channel 1c and the shape of the outer-facing peripheral surfaces of the tension ring members 2 and 2′ are configured to allow the surfaces to engage in a manner to inhibit relative rotation between the tension ring members 2 and 2′, and the housing 1, when the tension ring members 2 and 2′ are received within the channel 1c and expanded by the rotor member 3. In addition, a sufficient radial tension is provided between each tension ring member 2 and 2′ and its associated rotor member 3 and 3′, when the rotor member is received (pressed) within the tension ring member, to inhibit pivotal rotation of the rotor member 3 and 3′ (and connected lever member 4 and 4′) by gravity, while the lever member 4 and 4′ is coupled to a structural element (e.g., structural element 6 in FIGS. 8 and 9) of a device.

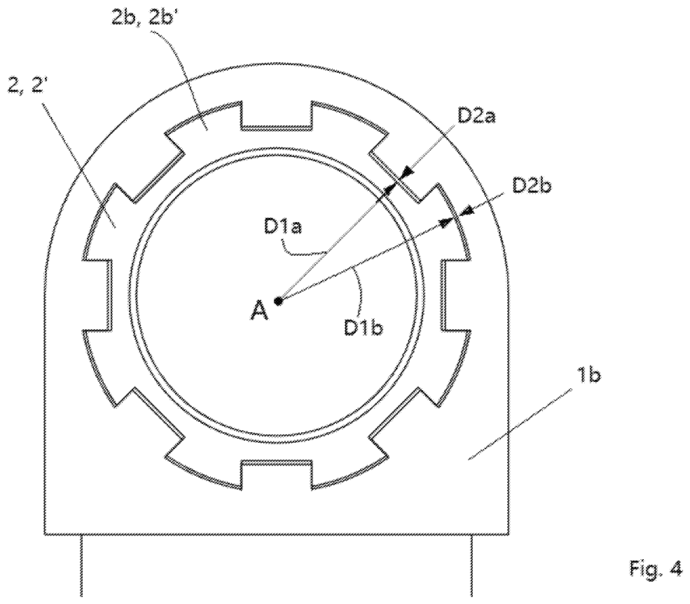

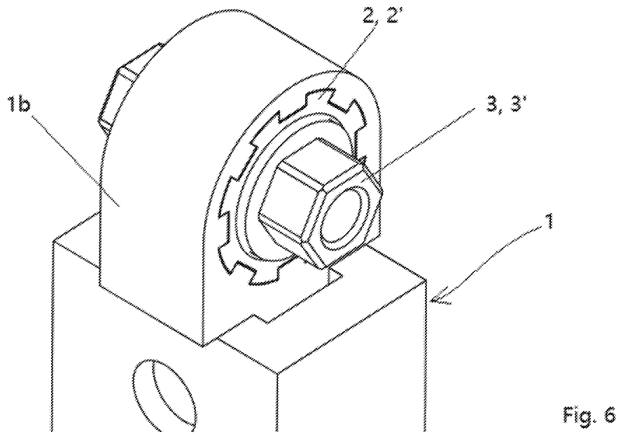

However, before the tension ring members 2 and 2′ are expanded by the rotor members 3 and 3′ (i.e., before the rotor members 3 and 3′ are inserted into the central openings 2a and 2a′ of the tension ring members 2 and 2′), the tension ring members 2 and 2′ easily fit within the channel 1c. For example, the outer diameter (or diameters D1a and D1b) and shape of each of the tension ring members 2 and 2′ may be sufficiently smaller than the inner diameter (or diameters D2a and D2b) and the shape of the channel 1c, to allow the tension ring members 2 and 2′, to easily fit within the channel 1c. In that state, the tension ring members 2 and 2′ may be manually slid into one or both sides of the channel 1c from one or both sides of the head portion 1b, and a small gap may remain between at least a portion of the outer peripheral surface of each tension ring member 2 and 2′ and the inner peripheral surface of the channel 1c, as shown in FIG. 4. Then, while the tension ring members 2 and 2′ are within the channel 1c, the rotor members 3 and 3′ are inserted into the central openings 2a and 2a′, causing the outer diameter and shape of each of the tension ring members 2 and 2′ to expand outward and take up some or all of the above-noted gap, as shown in FIG. 6.

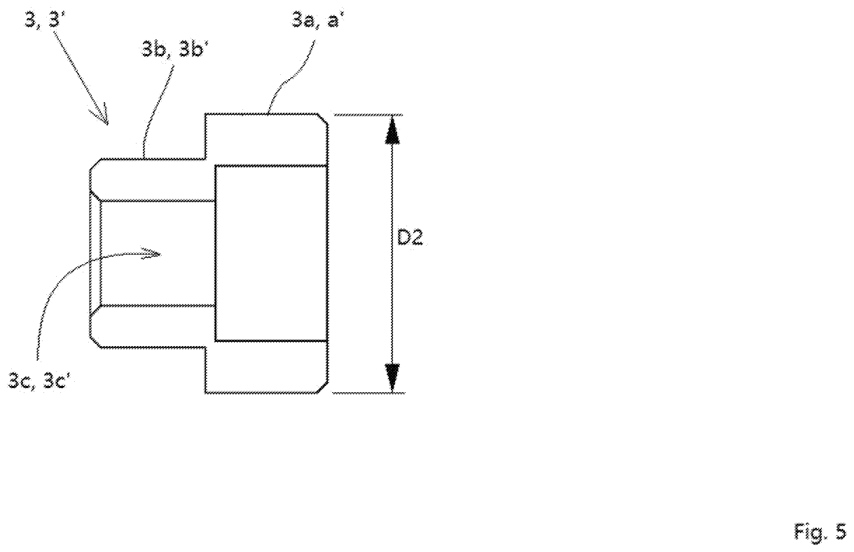

Before receiving the rotor members 3 and 3′, the central openings 2a and 2a′ in the tension ring members 2 and 2′ have a diameter D3, that is slightly (or sufficiently) smaller than the outer diameter D4 of the rotor members 3 and 3′ (as shown in FIGS. 4 and 5). The rotor member 3 may be received within the opening 2a of the tension ring member 2 by being pressed or otherwise forced into the opening 2a. Similarly, the rotor member 3′ may be received within the opening 2a′ of the tension ring member 2′ by being pressed or otherwise forced into the opening 2a′.

The tension ring members 2 and 2′ are generally rigid, but have sufficient elasticity due to their shape and material, to expand radially outward, as the rotor member 3 is forced into the opening 2a. The tension ring members 2 and 2′ may be made of any suitable material including a wearing metal of sufficiently high tensile strength and retractable tension when elongated to provide the strength, flexibility, tension and resilience to function as described herein, such as, but not limited to beryllium bronze, other high tensile steel alloy or other metal or metal alloy, plastic, ceramic, composite material, or the like. The rotors 3 and 3′ may be made of any suitable material including a relatively hard wearing material, such as, but not limited to a hardened steel alloy, hardened copper alloy or other metal or metal alloy, plastic, ceramic, composite material, or the like. In certain examples, the tension ring members 2 and 2′ are made of a metal (or other) material that is more elastic than the metal (or other) material of the rotor members 3 and 3′. The tension ring members 2 and 2′ and the rotors 3 and 3′ may be formed by any suitable manufacturing process or processes, including but not limited to molding, machining, extruding, or combinations thereof.

The shape of the inner-facing peripheral surface of the channel 1c of the housing 1, and the shape of the outer-facing peripheral surface of the tension ring members 2 and 2′ are configured to allow the surfaces to engage and inhibit relative rotation between the tension ring members 2 and 2′, and the housing 1, when the tension ring members 2 and 2′ are received within the channel 1c and are expanded by the rotor members 3 and 3′. In the example shown in FIGS. 1 and 2, the outer-facing peripheral surface of each tension ring member 2 and 2′ has a plurality of spokes, ribs or knurls 2b or 2b′ around the circumference of the tension ring member. In addition, the inner-facing peripheral surface of the channel 1c has a corresponding plurality of spoked indentations, grooves or detents that are shaped and arranged to receive the plurality of spokes, ribs or knurls of the tension ring members 2 and 2′.

The plurality of spokes, ribs or knurls on the tension ring member 2 (or 2′), when received in and engaged with the corresponding plurality of indentations, grooves or detents in the head portion 1c, inhibit rotation of the tension ring member 2 (or 2′) relative to the head portion 1c of the housing 1. The shaped configuration allow the tension ring member 2 (or 2′) to receive and withstand a relatively substantial amount of friction and torque from the rotor member 3 (or 3′) without rotating relative to the housing 1, when the rotor member 3 (or 3′) is received within the tension ring member 2 (or 2′) and rotated relative to the tension ring member.

In certain examples, each of the spokes, ribs or knurls has the same shape and size as each other spoke, rib or knurl, and the plurality of spokes, ribs or knurls are evenly spaced around the circumference and perimeter of each tension ring member 2 and 2′ (while the corresponding plurality of indentations, grooves or detents in the head portion 1b are of the same shape and size and evenly spaced around the circumference and perimeter of the channel 1c of the housing 1). Accordingly, each tensing ring member 2 and 2′ may be inserted into the channel 1c in any one of many possible rotational orientations (and need not be aligned in only one possible orientation for insertion). Thus, the evenly spaced and commonly sized and shaped perimeter features can help to simplify assembly. However, in other examples, the spokes, ribs or knurls may have different shapes or be spaced unevenly around the perimeter of each tension ring member 2 and 2′ (and the indentations, grooves or detents may have different shapes or sizes and may be spaced unevenly around the perimeter of the channel 1c).

As further shown in FIG. 3, each of the spokes, ribs or knurls on the tension ring members 2 and 2′ in FIGS. 1a and 1b have a shape that tapers wider, radially outward from axis A. Similarly, each of the indentations, grooves or detents in the head portion 1b have a corresponding radially-outward taper. The plurality of spokes, ribs or knurls (and corresponding indentations, grooves or detents) and their tapered shapes can inhibit rotation of the tension ring member 2 relative to the head portion 1c of the housing 1 and withstand a relatively substantial amount of friction and torque, while also minimizing the chance of stripping of rotation-inhibiting features on the peripheral surfaces of the tension ring members 2 and 2′ and the channel 1c.

However, in other examples, the shape of the inner-facing peripheral surface of the channel 1c and the shape of the outer-facing peripheral surfaces of the tension ring members 2 and 2′ may have other suitable shapes that inhibit relative rotation between the tension ring members 2 and 2′, and the housing 1, when the tension ring members 2 and 2′ are received within the channel 1c and are expanded by the rotor members 3 and 3′. Such other suitable shapes for the peripheral surfaces may include, but are not limited to a square, triangle, hexagonal, or other polygonal shape, oval or other curved, but not round shapes, or compound shapes (when viewed along the axis A).

Also as shown in FIG. 3, the central openings 2a and 2a′ in the tension ring members 2 and 2′ define an inner-facing surface 2c or 2c′. At least a portion of the inner-facing surface 2c or 2c′ of the tension ring member 2 or 2′ engages the outer surface of a rotor 3 or 3′, when the rotor member 3 or 3′ is inserted (or press fitted) into the central opening 2a or 2a′ of the tension ring member 2 or 2′. In the example in FIG. 3, the inner-facing surface 2c or 2c′ has a pair of raised, annular ribs that define a pair of raised surface regions 2d, 2d′ and 2e, 2e′ for contacting the rotor member 3 or 3′. In other examples, the inner-facing surface 2c or 2c′ may be annular but flat in the axial A direction (with no raised, annular rib or ribs), or may have one or more than two raised, annular ribs, each defining a raised surface region for contacting the outer surface of the rotor member 3 or 3′.

In the example in FIG. 3 in which the inner-facing surface 2c or 2c′ has at least two raised, annular ribs that define at least two raised surface regions 2d, 2d′ and 2e, 2e′, the rotor member 3 or 3′ may be stably supported by the tension ring member 2 or 2′, when the rotor member 3 or 3′ is inserted into the central opening 2a or 2a′ of the tension ring member 2 or 2′. In addition, the two raised surface regions 2d, 2d′ and 2e, 2e′ frictionally engage the outer surface of the rotor 3 or 3′ and, thus, provide two friction-engagement surfaces, when the rotor member 3 or 3′ is inserted into the central opening 2a or 2a′ of the tension ring member 2 or 2′. The surface area of friction-engagement surfaces, therefore, can depend upon the width and diameter of the raised surface regions 2d, 2d′ and 2e, 2e′ of the raised annular ribs.

In certain examples, the width and diameter of the raised surface regions 2d, 2d′ and 2e, 2e′ of the raised annular ribs is determined or configured to provide or contribute to the frictional force and resistance to rotational motion between the rotor member 3 or 3′ and the tension ring member 2 or 2′, when the rotor member 3 or 3′ is inserted into the central opening 2a or 2a′ of the tension ring member 2 or 2′. For example, the width and diameter of the raised surface regions 2d, 2d′ and 2e, 2e′ may be configured narrower to reduce the surface area of friction-engagement (to reduce frictional force and reduce resistance to rotational motion), or wider to increase surface area of friction-engagement (to increase frictional force and resistance to rotational motion).

Each rotor member 3 or 3′ includes a ring-engaging portion 3a or 3a′ having a surface for engaging the inner-facing surface 2c or 2c′ (or raised surface regions, such as 2d, 2d′ and 2e, 2e′) of the tension ring member 2 or 2′. Each rotor member 3 or 3′ also includes an extension portion 3b or 3b′, for engaging the lever member 4 or 4′. In particular examples, the rotor member 3 or 3′ (including the ring-engaging portion 3a or 3a′ and the extension portion 3b or 3b′) is formed as a single, unitary body. In other examples, the rotor member 3 or 3′ may be formed in two or more parts that are connected together.

In the example in FIGS. 1 and 2, and as shown in the partial cross-section view of FIG. 7, the ring engaging surface of the ring engaging portion 3a or 3a′ has a round, cylindrical shape. The outer diameter of the ring engaging surface is slightly (or sufficiently) larger than the diameter of the central opening 2a and 2a′ (or the diameter of one or more raised surface regions, such as raised surface regions 2d, 2d′ and 2e, 2e′) of the tension ring members 2 and 2′, before the rotor member 3 or 3′ is received within (e.g., pressed into) the central opening 2a or 2a′.

The extension portions 3b and 3b′ of the rotor members 3 and 3′ are configured to engage and connect to the lever members 4 and 4′, in a rotationally fixed manner (so as to not rotate relative each other). In the illustrated examples, each extension portion 3b or 3b′ has a polygonal shaped outer surface (in a plane perpendicular to the axis A), and each of the lever members 4 or 4′ have a correspondingly shaped and sized opening for receiving the extension portion 3b or 3b′. The polygonal shape of the outer surface of the extension portion 3b and 3b′ and the openings in the lever members 4 and 4′ inhibit the lever members 4 and 4′ from rotating relative to the extension portions 3b and 3b′ and, therefore, rotationally fix the lever members 4 and 4′ to the rotor members 3 and 3′, when the extension portions 3b and 3b′ are received in the openings in the lever members 4 and 4′. In other examples, the outer surfaces of the extension portions 3b and 3b′ and the openings in the lever members 4 and 4′ may have other suitable shapes for connecting together in a rotationally fixed manner. In further examples, the extension portions 3b and 3b′ may connect to the lever members 4 and 4′ in other suitable manners that rotationally fix each extension portion to a respective lever member.

In the example in FIG. 7, the head portion 1b of the housing 1 includes a central section or wall 1d within the channel 1c. The wall 1d can provide additional structural strength to the head portion 1b of the housing. The wall 1d divides the channel 1c into two channel sections, one for receiving the rotor member 3 and the other for receiving the rotor member 3′. The wall 1d defines an interior, back surface of each channel section. In the example of FIG. 7, each side of the wall 1d includes a receptacle 1f or 1f for receiving an end of a connector member 5 or 5′. In certain examples, each receptacle 1f or 1f includes a threaded channel or cylinder section having threads that engage with corresponding threads on the connector member 5 or 5′ in a screw-threading manner. In other examples, each receptacle 1f or 1f may couple to the connector member 5 or 5′ in other suitable manners, such as, but not limited to friction fitted connection, adhesives within the channels, solder, weld, rivet or the like. In examples in which the housing 1 (or at least the head portion 1b or wall 1d of the housing 1) is made of an electrically insulating material, the rotor members 3 and 3′ may be electrically isolated (insulated) from each other and, thus, can provide portions of a pair of separate electrical conduction paths, as described below. In other examples, the wall 1d may be omitted from the head portion 1b.

As shown in FIG. 7, each rotor member 3 and 3′ may include a central channel 3c and 3c′ that is open on the extension portion side (or both sides) of the rotor member. Each central channel 3c and 3c′ may have a single, consistent diameter along the axial length A of the channel. Alternatively, each channel 3c and 3c′ may include two (or more than two) diameters along its axial length. In the example in FIG. 7, the channel in each rotor member 3 and 3′ has a stepped diameter, defining a first diameter section along a first axial length, and a second diameter section along a second axial length of the channel. In FIG. 7, the first diameter section of the channel is smaller than the second diameter section of the channel, and extends from the outer-facing end of the rotor member 3 or 3′, toward the open end of the receptacle 1f or 1f′. The second diameter section of the channel extends from the first diameter end of the channel, to the wall 1d of the housing 1. The second diameter section (or larger diameter section) of the channel in each rotor member 3 and 3′ receives a receptacle 1f or 1f. The connector members 5 and 5′ extend through the first channel sections (or smaller diameter sections) of the channels in the rotor members 3 and 3′, and extend at least partially into the receptacles 1f and 1f′, as shown in FIG. 7. Each connector member 5 or 5′ may include a head portion 5a or 5a′ that extends at least partially over the lever 4 or 4′ to retain the lever 4 or 4′ on the rotor member 3 or 3′, when the connector member is connected to the rotor member.

A friction joint 10 as described herein may be attached to or included in a device having two or more structural element, for connecting the two or more structural elements together for pivotal movement relative to each other. In certain examples, the housing 1 may be coupled to a first structural element of a device, while the lever members 4 and 4′ may be coupled to a second structural element of the device. In other examples, one lever member 4 (or 4′) may be coupled to a second structural element of the device, while the other lever member 4′ (or 4) may be coupled to a third structural element of the device. In yet other examples, the housing 1 and lever members 4 and 4′ may be coupled to structural elements of two or more separate devices (where the friction joint 10 connects the two or more separate devices for pivotal motion relative to each other).

In particular examples, a friction joint 10 as described herein is attached to or included in a lighting device (such as, but not limited to a desk lamp, floor lamp, sconce, or fixture) having multiple structural elements (such as a base, one or more arms, legs or the like) that are connected together for pivotal motion. In the example in FIGS. 8 and 9, a friction joint 10 is shown as connecting a first structural element 6 with a second structural element 7. FIG. 8 shows a partial exploded view, to show an arrangement of the friction joint 10 relative to the structural elements 6 and 7. FIG. 9 shows the first and second structural elements 5 and 6 as connected together for pivotal motion relative to each other (about the axis A), by the friction joint 10. The first structure element 6 may be, for example, a base, leg or second arm of the lighting device, for supporting the first structural element 7. The second structural element 7 may be, for example, an arm or head of a lighting device and may contain or support one or more electronic light emitting devices (not shown in FIGS. 8 and 9).

In the example in FIGS. 8 and 9, each of the structural elements 6 and 7 is a hollow tube or cylindrical-shaped member having a rectangular cross-section shape (taken perpendicular to the length dimension of the tube or cylindrical shape). In other examples, the structural elements 7 and 7 may have other suitable tubular-shaped or non-tubular configurations. The structural elements 6 and 7 may be made of any suitably rigid material such as, but not limited to metal, plastic, wood, composite material, ceramic or the like.

The housing 1 of the friction joint 10 may be configured to fit within (or partially within) the hollow interior of the tube-shaped first structural element 6, with the head portion 1b of the housing 1 extending at least partially out of one end of the tube-shaped first structural element 6. The tube-shaped first structural element 6 may include one or two extension portions 6a and 6b, that extend over and cover a portion of the lever members 4 and 4′ (and the connector members 5 and 5′), when the friction joint 10 is received within the tube-shaped first structural element 6, as shown in FIG. 9. The tube-shaped first structural element 6 may include a hole 6c that aligns with a corresponding hole 1e on the housing 1, when the friction joint 10 is received within the tube-shaped first structural element 6. A further connector member (such as, but not limited to a screw, bolt or other threaded connector, rivet or the like) may be extended through the holes 6c and 1e, to secure the friction joint 10 to the first structural element 6. In other examples, other suitable mechanisms for securing the housing 1 to the first structural element 6 may be employed, including, but not limited to adhesives, welds or the like. Similarly, the lever members 4 and 4′ may extend at least partially into the hollow interior of the tube-shaped second structural element 7, and may be secured to the tube-shaped second structural element 7 by any suitable mechanism including, but not limited to threaded or non-threaded connectors, adhesives, welds, or the like.

In certain examples, the second structural element 7 contains or holds one or more electronic devices such as, but not limited to lighting devices (such as, but not limited to LEDs, fluorescent lights, incandescent lights, combinations thereof, or the like. In yet other examples, the structural element 7 contains or holds one or more other electronic devices or non-electronic devices instead of or in combination with one or more electronic lighting devices, where such other electronic devices or non-electronic devices may include, but are not limited to, tools, medical instruments or medical devices, musical instruments or musical devices, prosthetic devices, television or monitor support or mounting devices, book mounting devices, computer mounting devices, or the like.

In examples in which the second structural element 7 contains or holds one or more electronic devices, the hollow interior of the structural element 7 may contain or include one or more electrical conductors for providing electrical power or control signals (or both) to the one or more electronic devices. For example, a first set of one or more (or a pair) of insulated electrical wires or other electrical conductors may extend through at least a portion of the hollow interior of the structural element 7, from the one or more electronic devices to the friction joint 10. One electrical conductor 8 (FIG. 7) of the first set of conductors may be electrically coupled to one tension ring member 2 (where the tension ring member 2 is made of an electrically conductive material). A second electrical conductor 8′ (FIG. 7) of the first set of conductors may be electrically coupled to the other tension ring member 2′ (where the tension ring member 2′ is made of an electrically conductive material).

A second set of one or more (or a pair) of insulated electrical wires or other electrical conductors may extend through at least a portion of the hollow interior of the structural element 7, from a power source or power inlet (or from a control signal source or input) to the friction joint 10. One electrical conductor 9 (FIG. 7) of the second set of conductors may be electrically coupled to one of the tension ring members 2. A second electrical conductor 9′ (FIG. 7) of the second set of conductors may be electrically coupled to the other tension ring member 2′. Accordingly, the electrical conductors 8 and 9 provide a first electrical conduction path through the friction joint 10, between a power source or power inlet (or from a control signal source or input) and one or more electronic devices contained in or held by the structural element 7. Similarly, the electrical conductors 8′ and 9′ provide a second electrical conduction path through the friction joint 10, between a power source or power inlet (or from a control signal source or input) and one or more electronic devices contained in or held by the structural element 7.

In further examples, the electrical conductor 8 may include a ring-shaped portion arranged around the axis A, and may be electrically connected or contacted with a similar ring-shaped portion of the electrical conductor 9 that is also arranged around the axis A. In such further examples, the electrical conductor 9 may have a further portion that extends from the ring-shaped portion, into and through at least a portion of the housing portion 1a. In such further examples, the connector member 5 may urge the ring-shaped portions of the electrical conductors 8 and 9 together to form or maintain an electrical connection between those conductors. Similarly, a ring shaped portion of the electrical conductors 8′ and 9′ may be arranged around the axis A, and in electrical contact with each other. In such further examples, the tension ring members 2 and 2′ or the rotor members 3 and 3′ (or both) need not be made of an electrically conductive material.

In yet further examples, each of the electrical conductors 8 and 8′ may include a ring-shaped portion arranged around the axis A as described above, but each of the electrical conductors 9 and 9′ may be electrically coupled to a respective one of the tension ring members 2 and 2′. In such yet further examples, the electrical conductors 8 and 9 and the tension ring member 2 provide a first electrical conduction path through the friction joint 10, between a power source or power inlet (or from a control signal source or input) and one or more electronic devices contained in or held by the structural element 7. Similarly, the electrical conductors 8′ and 9′ and the tension ring member 2′ provide a second electrical conduction path through the friction joint 10, between a power source or power inlet (or from a control signal source or input) and one or more electronic devices contained in or held by the structural element 7. Accordingly, the friction joint 10 may be included in an electrical conduction path for a pair of electrical conductors.

When the housing 1 is secured to the first structural element 6, and the lever members 4 and 4′ are secured to the second structural element 7, the friction joint 10 provides a pivotal connection between the structural elements 6 and 7. The pivotal connection allows the structural elements 6 and 7 to be pivoted relative to each other, about the axis A. In addition, the frictional engagement of the rotor members 3 and 3′ with the tension ring member 2 and 2′, allow the friction joint 10 to hold or maintain the pivotal position of the structural elements 6 and 7 (against the force of gravity), but allow a user (or other device or instrument) to pivotally move the structural elements 6 or 7 relative to each other (by application of suitable manual or mechanical force), to adjust the pivotal position (or angle) of the structural elements 6 and 7 relative to each other.

In example in FIGS. 3 and 4, the tension ring member 2 has a plurality of evenly spaced, and similarly shaped spokes, ribs or knurls (and the head portion 1b of the housing 1 has a corresponding plurality of evenly spaced and similarly shaped indentations, grooves or detents). However, in other examples, the spokes, ribs or knurls may have different shapes or be spaced unevenly around the perimeter of each tension ring member 2 and 2′ (and the indentations, grooves or detents may have different shapes or sizes and may be spaced unevenly around the perimeter of the channel 1c).

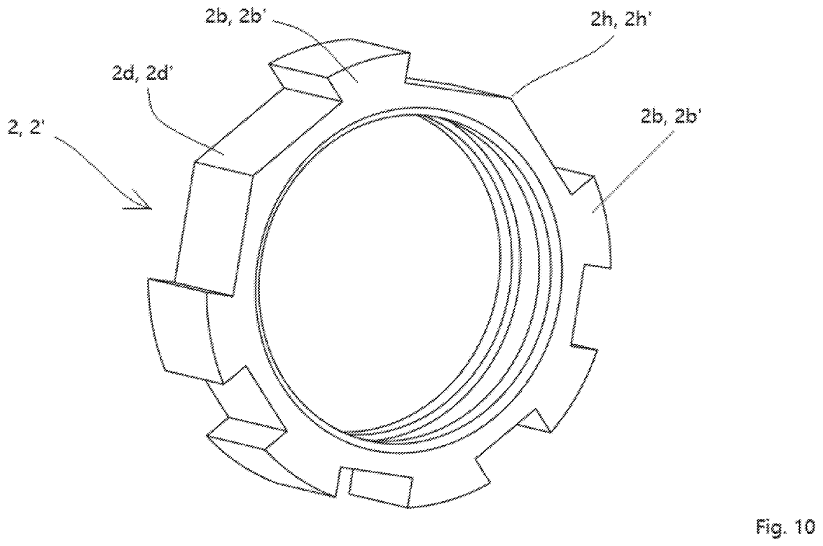

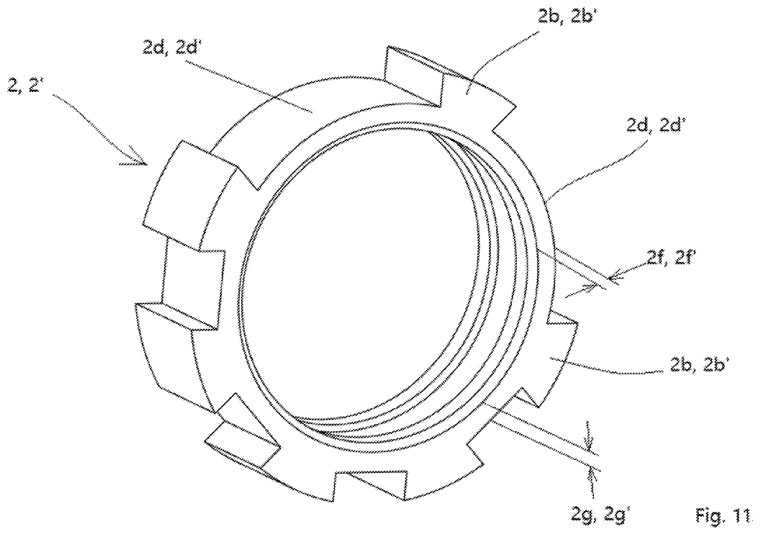

For example, as shown in FIGS. 10 and 11, spokes, ribs or knurls are spaced unevenly around at least a portion of the perimeter of each tension ring member 2 and 2′. That arrangement results in one or more (two in FIGS. 10 and 11) portions of the tension ring member 2 or 2′ having a relatively large spacing 2d, 2d′ between two or more adjacent spokes, ribs or knurls, relative to other adjacent spokes, ribs or knurls. Each relative large spacing 2d, 2d′ results in a portion of the annular length being more flexible or resilient, than other portions (portions having more closely spaced spokes, ribs or knurls).

To further control flexibility or resilience of the tension ring members 2 and 2′ the radial thickness of the tension ring members can be selected. For example, to enhance flexibility and resilience, the radial thickness of the entire tension ring member or of portions of the tension ring member 2 or 2′ can be selected or made thinner. Similarly, to reduce flexibility and resilience, the radial thickness of the entire tension ring member or of portions of the tension ring member 2 or 2′ can be selected or made thicker. For example, with reference to FIG. 11, each of the large spacing sections 2d, 2d′ between adjacent spokes, ribs or knurls of the tension ring member 2, 2′ may be provided with a thinner radial thickness dimension 2f, 2f, relative to the thicker radial thickness dimension 2g, 2g′ of the tension ring member 2, 2′ at the smaller spacing sections between other adjacent spokes, ribs or knurls. In other examples, the radial thickness dimensions of the entire tension ring member 2, 2′ or of one or more other sections of the tension ring member 2, 2′ may be selected and configured to provide a desired amount of flexibility and resilience for the intended application of use.

Accordingly, by selecting and providing tension ring members 2 and 2′ with one or more relatively large spacing 2d, 2d′ between adjacent spokes, ribs or knurls, or by selecting and configuring the radial thickness of tension ring members 2 and 2′ (or of selected sections of the tension ring members), the relative flexibility and resilience of the tension ring members 2 and 2′ can be selected and configured, as appropriate for the intended application of use of the friction joint 10. In this manner, the arrangement (and spacing) of spokes, rigs or knurls on the tension ring members 2 and 2′ may be configured to provide the tension ring member 2 and 2′ with more (or a desired) structural flexibility and resilience, to provide a greater amount or greater force of radial expansion within the channel 1c of the housing 1, when the rotor member 3 and 3′ is pressed into the tension ring members 2 and 2′.

As described herein, the friction joint 10 is configured to allow pivotal movement of the lever members 4 and 4′ (and at least one second structural element 7) relative to the housing 1 (and a first structural element 6), about an axis A. In addition, the friction joint 10 is configured to hold and maintain the lever members 4 and 4′ (and at least one second structural element 7) against gravity, in one or more (of multiple) different rotational positions about the axis A. However, the radial friction force of the friction joint can be overcome by application of a sufficient manual or mechanical force, to allow manual or mechanical adjustment of the pivotal position of the lever members 4 and 4′ (and each second structural element 7) relative to the housing 1 (and the first structural element 6). In particular examples, the amount of radial friction between the tension ring members 2 and 2′ and the rotor members 3 and 3′ (and, thus, the amount of force or torque that the rotary members 3 and 3′ can hold without rotation) can be selected or adjusted, by selecting or adjusting one or more of the following parameters:
a. The diameter of the channel 1c in the housing 1 and the outer diameter of the ring-engaging portion 3b or 3b′ of the rotor 3 or 3′ (or the relative diameters of those components);
b. The radial thickness dimensions of the tension ring members 2 and 2′ (or the relative flexibility and resilience of each tension ring member around its perimeter);
c. The width dimensions (in the axial direction A) of the rotor member contacting surfaces 2e, 2e′ and 2f, 2f′ of the tension ring members 2 and 2′ (or the surface area of contact between each tension ring member and an associated rotor member);
d. The sum of lengths between adjacent spokes, ribs or knurls; and
e. The material from which the tension ring members 2 and 2′ are made (or the relative flexibility and resilience of each tension ring member).

In examples described herein, the first set of further components (including the first tension ring member 2, the first rotor member 3 and the first lever member 4) may be identical and interchangeable with the second set of further components (including the second tension ring member 2′, the second rotor member 3′, and the second lever member 4′, for example, to simplify and reduce the cost of manufacture. In other examples, the first set of further components (including the first tension ring member 2, the first rotor member 3 and the first lever member 4) may be different from the second set of further components (including the second tension ring member 2′, the second rotor member 3′, and the second lever member 4′), for example, for applications in which the lever members 4 and 4′ connect to different structural elements.

A friction joint 110 according to a further example is shown in FIG. 12 and has a configuration and operation similar to the friction joint 10 discussed herein. For example, the friction joint 110 includes a housing 101 having a channel 101c (which may be similar to the housing 1 and channel 1c described herein). However, the housing 101 in FIG. 12 is shaped differently relative to the housing 1, and has an interior volume that contains power source electronics, such as, but not limited to one or more of a transformer (AC to DC transformer), a driver circuit for LEDs or other light emitting devices, a battery, or the like, For example, the housing 101 contains may contain a transformer and driver circuit connected to receive electrical power through a single or multi-conductor power cable 101a that extends out from the housing 101 to a power source (such as, but not limited to, an AC electrical outlet or other AC power source, not shown).

The friction joint 110 includes a pair of lever members 104 and 104′ (which may be similar to the lever members 4 and 4′ described herein). The friction joint 110 includes a pair of tension ring members 102 and 102′ (which may be similar to the tension ring members 2 and 2′ described herein). While the tension ring members 102 and 102′ are shown in FIG. 12 on the outside of the lever members 4 and 4′, relative to the position of the housing 101 between the lever members 4 and 4′, it will be understood that the tension ring members 102 and 102′ fit within a channel 101c of housing 101 in a manner similar to the manner in which the tension ring members 2 and 2′ fit within the channel 1c of the housing 1 described herein.

The friction joint 110 also includes a pair of rotor members 103 and 103′ (which may be similar to the rotor members 3 and 3′ described herein). The rotor members 103 and 103′ have a ring-engaging portion 103a and 103a′ and a lever engaging portion 103b and 103b′ that extend through or into openings in the lever members 104 and 104′ (similar to the ring engaging portion 3a and 3a′ and the lever engaging portion 3b and 3b′ of the rotor members 3 and 3′ described herein). However, the rotor members 103 and 103′ have a relatively large diameter head portion 103c and 103c′ (having a diameter larger than the opening of the openings in the lever members 104 and 104′) to inhibit the rotor member 103 or 103′ from passing all of the way through the lever member 104 or 104′.

The friction joint 110 may include a pair of connector members 105 and 105′ (similar to connector members 5 and 5′ described herein). In particular examples, the connector members 105 and 105′ may connect (e.g., by threaded connection or other suitable connection) with a receptacle 101b (e.g., a threaded or other suitable receptacle) on the housing 101.

When assembled, the friction joint 110 operates similar to the friction joint 10 described herein. In the example shown in FIG. 12, each of the lever members 104 and 104′ are bent away from the other lever member to provide a widened region between the lever members 104 and 104′ in which the housing 101 is arranged. The lever member 104 and 104′ are closer to each other, on the upper side (in the drawing) of the bent portion. In particular examples, a separation member 106 may be arranged between the lever members 104 and 104′ (e.g., along at least a portion of the lengths of the lever members 104 and 104′ that are on the side of the bent portion to be closer to each other. The separation member 106 may be made of any suitable electrically insulating material, to electrically insulate the lever members 104 and 104′ from each other, for example, in embodiments in which the friction joint 110 is part of an electrical conduction path as described herein. In particular examples, the separation member 106 may be a strip, layer, coating of plastic or other electrically insulating material that is provided on (attached or adhered to) one or each of the lever members 104 and 104′, on the surface facing the other lever member 104 and 104′. In the illustrated example, the separation member 106 includes a protrusion 106a on one or both sides, for aligning with and fitting within a corresponding recess or opening in one or each of the lever members 104 and 104′, to assist in alignment and attachment of the separation member 106 to one or both lever members.

In the example in FIG. 12, the housing 101 includes an opening 101e or other mounting structure for mounting to a base member 107. The base member 107 may include an extension portion 107a that fits into the opening in the housing 101, to connect the housing 101 onto the base member 107.

Example friction joints and devices that include such friction joints as described herein may be manufactured and assembled in any suitable manner. In certain examples, a manufacturing or assembly method may include providing a housing 1 (or 101) by injection molding or other suitable processes, providing one or two sets of further components by injection molding, stamping or machining, where each further set of components includes a tension ring member, a rotor member and a lever member. The tension ring member of each further set of components may be inserted into (e.g., manually slid into) one side opening of the channel 1c (or 101c) of the housing 1 (or 101). A rotor member may be inserted (e.g., pressed) into the central opening of each tension ring member, to cause the tension ring member to expand within the channel 1c (or 101c) of the housing 1 (or 101). A lever member may be placed onto the lever member engaging portion of each rotor member, and a connector member may be secured to the rotor member, to hold the lever member in place.

The housing 1 (or 101) may be mounted to a first structural element of a device (such as, but not limited to a base, leg or arm of a lighting device). The lever members may be mounted to a second structural element of the device (such as, but not limited to an arm of a lighting device). Electrical connections to light emitting devices on or held by the second structural may be made, through an electrical conduction path extending through the friction joint, as described.

While various exemplary embodiments have been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A friction joint comprising:
a housing having a channel;
a first tension ring member arranged within the channel, the first tension ring member having an outer dimension that is resiliently expandable, the first tension ring member having a central opening;
a first rotor member configured to be received within the central opening of the first tension ring member while the first tension ring member is within the channel of the housing, the first rotor member causing the outer dimension of the first tension ring member to expand within the channel of the housing and press against at least a portion of the housing when the first rotor member is received within the central opening of the first tension ring member, the first rotor member being frictionally engaged with and rotatable relative to the first tension ring member when the first rotor member is received within the central opening of the first tension ring member; and
a first lever member secured to the first rotor, to rotate with the first rotor, relative to the first tension ring member.

2. A friction joint of claim 1, further comprising:
a second tension ring member arranged within the channel, the second tension ring member having an outer dimension that is resiliently expandable, the second tension ring member having a central opening;
a second rotor member configured to be received within the central opening of the second tension ring member while the second tension ring member is within the channel of the housing, the second rotor member causing the outer dimension of the second tension ring member to expand within the channel of the housing and abut against at least a portion of the housing when the second rotor member is received within the central opening of the second tension ring member, the second rotor member being frictionally engaged with and rotatable relative to the second tension ring member when the second rotor member is received within the central opening of the second tension ring member; and
a second lever member secured to the second rotor, to rotate with the second rotor, relative to the second tension ring member.

3. A friction joint of claim 2, wherein the housing has a wall that divides the channel into first and second channel sections, wherein the first tension ring member is arranged within the first channel section of the channel, and wherein the second tension ring member is arranged within the second channel section of the channel.

4. A friction joint of claim 3, wherein the wall of the housing has a first receptacle for receiving a portion of a connector member that extends through the first rotor member.

5. A friction joint of claim 4, wherein the wall of the housing has a second receptacle for receiving a portion of a second connector member that extends through the second rotor member.

6. A friction joint of claim 1, wherein the first tension ring member is configured to secure in a fixed relation to the housing when the first tension ring member is expanded within the channel of the housing and pressed against the portion of the housing.

7. A friction joint of claim 1, wherein the channel of the housing has a plurality of indentations, grooves or detents, and wherein the first tension ring member has an outer peripheral surface that has a plurality of spokes, ribs or knurls configured to be received within the plurality of indentations, grooves or detents in the channel of the housing, when the first tension ring member is expanded within the channel of the housing and pressed against the portion of the housing.

8. A friction joint of claim 7, wherein the plurality of indentations, grooves or detents are evenly spaced around and extend outward from a perimeter of the first tension ring.

9. A friction joint of claim 7, wherein the plurality of spokes, ribs or knurls includes a first pair of adjacent spokes, ribs or knurls and a second pair of adjacent spokes, ribs or knurls, wherein a spacing between the first pair of adjacent spokes, ribs or knurls is larger than a spacing between the second pair of spokes, ribs or knurls.

10. A friction joint of claim 9, wherein the first tension ring has a first radial thickness dimension in a region corresponding to the spacing between the first pair of adjacent spokes, ribs or knurls, and a second radial thickness in a region corresponding to the spacing between the second pair of adjacent spokes, ribs or knurls, and wherein the first radial thickness is smaller than the second radial thickness.

11. A friction joint of claim 7, wherein the plurality of spokes, ribs or knurls includes a plurality of first pairs of adjacent spokes, ribs or knurls and a plurality of second pairs of adjacent spokes, ribs or knurls, wherein a spacing between each first pair of adjacent spokes, ribs or knurls is larger than a spacing between each second pair of spokes, ribs or knurls.

12. A friction joint of claim 1, wherein the outer dimension of the first tension ring has a first diameter when the first rotor member is not within the central opening of the first tension ring member, and is expanded to a second diameter when the first rotor member is received within the central opening of the first tension ring member; and
wherein the second diameter is larger than the first diameter.

13. A friction joint of claim 1, wherein:
the channel of the housing has an open end;
the first outer diameter of the first tension ring member is sufficiently small relative to the channel of the housing to allow the first tension ring to be manually slid into or out of the open end of the channel of the housing;
the second outer diameter of the first tension ring member is sufficiently large relative to the channel of the housing to cause at least a portion of the first tension ring member to press against an inner surface of the channel.

14. A friction joint of claim 1, wherein the central opening of the first tension ring member defines an inner wall having at least two raised contact surfaces for engaging the first rotor member when the first rotor member is received within the central opening of the first tension ring member.

15. A lighting device having a first structural member and a second structural member, the second structural member containing or supporting at least one light emitting device, the first structural member and the second structural member being coupled together with the friction joint of claim 1, for pivotal motion relative to each other.

16. A support system comprising:
a first structural element;
a second structural element;
a friction joint connecting the first structural element and the second structural element for relative pivotal motion, the friction joint comprising:
a housing having a channel, the housing being fixed to the first structural element;
a first tension ring member arranged within the channel, the first tension ring member having an outer dimension that is resiliently expandable, the first tension ring member having a central opening;
a first rotor member configured to be received within the central opening of the first tension ring member while the first tension ring member is within the channel of the housing, the first rotor member causing the outer dimension of the first tension ring member to expand within the channel of the housing and press against at least a portion of the housing when the first rotor member is received within the central opening of the first tension ring member, the first rotor member being frictionally engaged with and rotatable relative to the first tension ring member when the first rotor member is received within the central opening of the first tension ring member; and
a first lever member secured to the first rotor, to rotate with the first rotor, relative to the first tension ring member, the first lever member being fixed to the second structural element.

17. A support system claim 16, wherein the first tension ring member is configured to secure in a fixed relation to the housing when the first tension ring member is expanded within the channel of the housing and pressed against the portion of the housing.

18. A support system of claim 16, wherein the channel of the housing has a plurality of indentations, grooves or detents, and wherein the first tension ring member has an outer peripheral surface that has a plurality of spokes, ribs or knurls configured to be received within the plurality of indentations, grooves or detents in the channel of the housing, when the first tension ring member is expanded within the channel of the housing and pressed against the portion of the housing.

19. A support system of claim 16, wherein the outer dimension of the first tension ring has a first diameter when the first rotor member is not within the central opening of the first tension ring member, and is expanded to a second diameter when the first rotor member is received within the central opening of the first tension ring member; and
wherein the second diameter is larger than the first diameter.

20. A support system of claim 16, wherein:
the channel of the housing has an open end;
the first outer diameter of the first tension ring member is sufficiently small relative to the channel of the housing to allow the first tension ring to be manually slid into or out of the open end of the channel of the housing;
the second outer diameter of the first tension ring member is sufficiently large relative to the channel of the housing to cause at least a portion of the first tension ring member to press against an inner surface of the channel.
